(19) United States
(12) Patent Application Publication
(10) Pub. No.: US 2004/0098444 A1
(43) Pub. Date: May 20, 2004

(54) Method and apparatus for synchronizing electronic agendas

(76) Inventors: Henrik Bengtsson, Lund (SE); Carl-Johan Ivarsson, Lund (SE)

Correspondence Address: JENKENS & GILCHRIST, PC, 1445 ROSS AVENUE, SUITE 3200, DALLAS, TX, 75202, US

(21) Appl. No.: 10/250,752

(22) PCT Filed: Dec. 18, 2001
(86) PCT No.: PCT/SE01/02802

(30) Foreign Application Priority Data
Jan. 9, 2001 (SE) 01000496

(51) Int. Cl. G06F 15/16

(52) U.S. Cl. 709/200; 709/400; 711/100

(57) ABSTRACT

An information processing system comprises a synchronization engine (11) for synchronizing a first electronic agenda (7a) comprising non-text information with a second electronic agenda (7b) for storage of text information. The synchronization engine (11) is adapted to receive non-text information from the first agenda (7a), reproduce the non-text information and receive text information entered by a user, corresponding to said non-text information for storage in the second agenda (7b).

### TECHNICAL FIELD

The present invention relates to an information processing system, and more specifically to an information, processing system comprising a synchronization engine which provides a synchronization function for synchronizing a first electronic agenda comprising text and non-text information with a second electronic agenda comprising text and non-text information.

### PRIOR ART

The set-up storage of Personal Information Management (PIM) data has today moved away from traditional paper-based agendas to electronic devices. At the same time group scheduling applications are included in the Information Systems/Information Technology (IS/IT) infrastructure of companies and the interaction between these two information centers e.g. a stationary computer such as a personal computer (PC) and an electronic PIM-device becomes important. The most common solution is automatic synchronization between the two data storages.

The user interface on a PC compared to an electronic device is though different and the situations when the devices are used differ. Typically the user interface on the PIM-device is smaller than a PC interface and the user have the possibility to move around more freely when using the PIM-device instead of a stationary computer. One way of making the user interface smaller is to remove or to reduce the size of the keyboard and use a touch-based pen input combined with a large display.

It is very easy for a user to read from an agenda on a PIM-device with a large display, but usually it is more difficult to enter text due to the small size of the PIM-device. This is even more tangible in a moving situation e.g. when the user travels by car. In situations like these voice notes (short user-recorded memos) are a better approach to input information. Thus, entries in the electronic agenda on the PIM-device will be stored as “voice bookings” comprising sound and possibly text. This technique is well known and practiced in the state of the art PIM-devices, such as the Psion Series 5mx from Psion PLC, 1 Red Place, London, W1Y 3RE, United Kingdom, in which a recorded voice note may be added to a text entry in the electronic agenda thereon. It is then possible to listen to the voice note when the voice booking entry containing the voice note is selected in the electronic agenda.

When the PIM-device is operated in conjunction with its associated connectivity software and link cable, synchronization functionality is provided between the stationary computer (PC) and the PIM-device. However, when synchronization between the electronic agenda on the PIM-device, comprising both text and voice notes, and the electronic agenda on the stationary computer is performed, the text information part of the entries only is synchronized and the voice note is hence discarded in the synchronization process. Thus, there is no way to transfer the voice note directly from the electronic agenda on the PIM-device to the electronic agenda on the stationary computer. The same procedure applies when the entries in the electronic agenda on the PIM-device contain other kind of non-text information (e.g. pictures).

### SUMMARY OF THE INVENTION

It is an object of the present invention to provide an information processing system, which allows both text information and non-text information such as sound to be synchronized between two electronic agendas, thereby allowing the user to freely input information into an electronic agenda in a way that is most efficient at the time. Furthermore, it is an object of the present invention to provide a user-friendly interface by which the user in an easy way can convert an entry in the electronic agenda, containing both text information and non-text information into a text-only entry in the other agenda.

A more specific object of the invention is to provide a synchronization engine, which allows a user with a PIM-device containing voice notes to transfer these to a text-based electronic agenda on a PC.

The above objects are achieved by a synchronization engine, controlling the synchronization process between the electronic agendas to detect non-text information sequences in the entries in the electronic agendas during the synchronization process and reproduce the information sequences. The user then manually converts the non-text information (e.g. a voice note) into text by means of a keyboard, or waits with the conversion until later on.

Alternatively, if both agendas support non-text entries, the synchronization engine may, at the user's discretion, perform a full synchronization, i.e. the non-text entry parts may be transferred between the agendas in their original format.

An advantage is that an information processing system provided with a synchronization engine according to the present invention is due to its low complexity much less memory intensive and thus well suited for electronic devices with a limited memory capacity.

Other objects, features and advantages of the present invention appear from the following detailed disclosure, from the appended claims as well as from the accompanying drawings.

### BRIEF DESCRIPTION OF THE DRAWINGS

A preferred embodiment of the present invention will now be described in more detail, reference being made to the accompanying drawings, in which:

FIG. 1 is a simplified schematic view of an interconnection between a mobile PIM-device and a stationary computer such as a personal computer (PC) provided with the system according to the invention,

FIG. 2 is a schematic flow diagram of the main steps of a method according to the invention, and

FIG. 3 is a schematic block diagram of a synchronization engine according to a preferred embodiment.

### DETAILED DISCLOSURE OF A PREFERRED EMBODIMENT

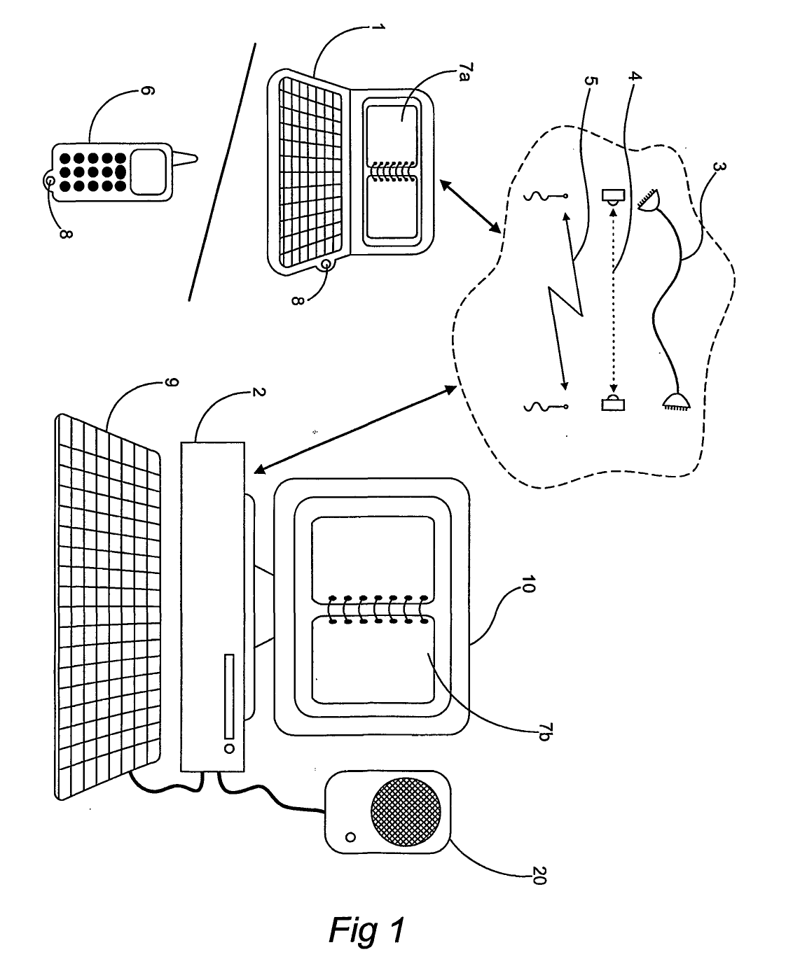

FIG. 1 illustrates one possible way to physically connect a PIM-device 1 to a stationary computer (PC) 2. Although the description of a preferred embodiment below is based on the synchronization of electronic agendas in the memories of a mobile PIM-device and a PC respectively, it is understood that the actual storage means for the electronic agendas is of lower importance.

The connection between the PIM-device 1 and the PC 2 can be made by using a cable 3, infrared light 4, radio waves 5, or any other medium suitable for transmitting information. Many different standards are available for transmitting information between to computers. The IrDA (Infrared Data Association) standard proposes a solution for a high speed short range, line of sight, point-to-point cordless data transfer by the use of infrared light. The Bluetooth standard offers, in a broader sense, a similar solution by the use of radio waves instead of infrared light. The specific choice of information carrying medium is not important for the function of the present invention and depends solely upon under which specific circumstances the PIM-device 1 and the PC 2 is to be connected. For example, if the PIM-device 1 is incorporated in a mobile communication device, e.g. a mobile telephone 6 with an increased functionality, where the physical size of the communication device is very small, a cordless communication channel 4, 5 is preferably used instead of a bulky multi-wire cord and its associated connector 3.

In the description below, an electronic agenda 7a residing on the PIM-device 1 is optimized for “mobile” use, i.e. instead of just containing text, it may also store and present voice memos, who the user, in a situation where the use of a keyboard is not practicable, has recorded using a built-in microphone 8. The optimization is also, in some extent, performed to compensate for the physical size of the PIM-device 1 which does not allow for effective use of a keyboard. In addition to voice memos, entries on the electronic agenda 7a may also contain other kind of non-text information such as pictures or sketches.

An agenda 7b residing on the PC 2 is of a text-based type. Normally when using an agenda 7b on the stationary computer 2, there is no actual need to use voice-memos since a keyboard 9 and a screen 10, forming an integral part of an ordinary PC 2, very well support the use of the text-based agenda 7b.

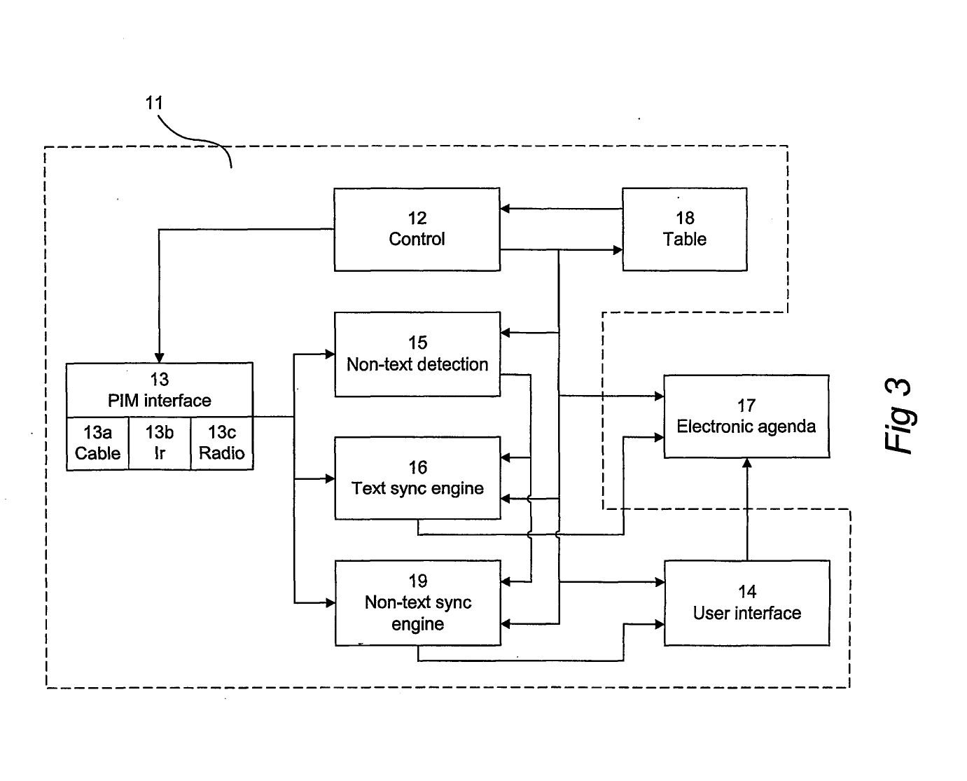

With reference to FIG. 3, a software synchronization engine 11 according to a preferred embodiment is residing on the PC 2 together with the text-based agenda 7b, which makes it easy to adapt the synchronization engine 11 to form entries in the text-based agenda 7b. The synchronization engine 11 may reside on the PIM-device 1, but this implies that the voice-memos are converted into text only-entries by using the PIM-device 1 before synchronization. As can be understood, this will compel the user to enter text directly into the PIM-device 1, which, as mentioned above, is cumbersome when the user is in a moving situation.

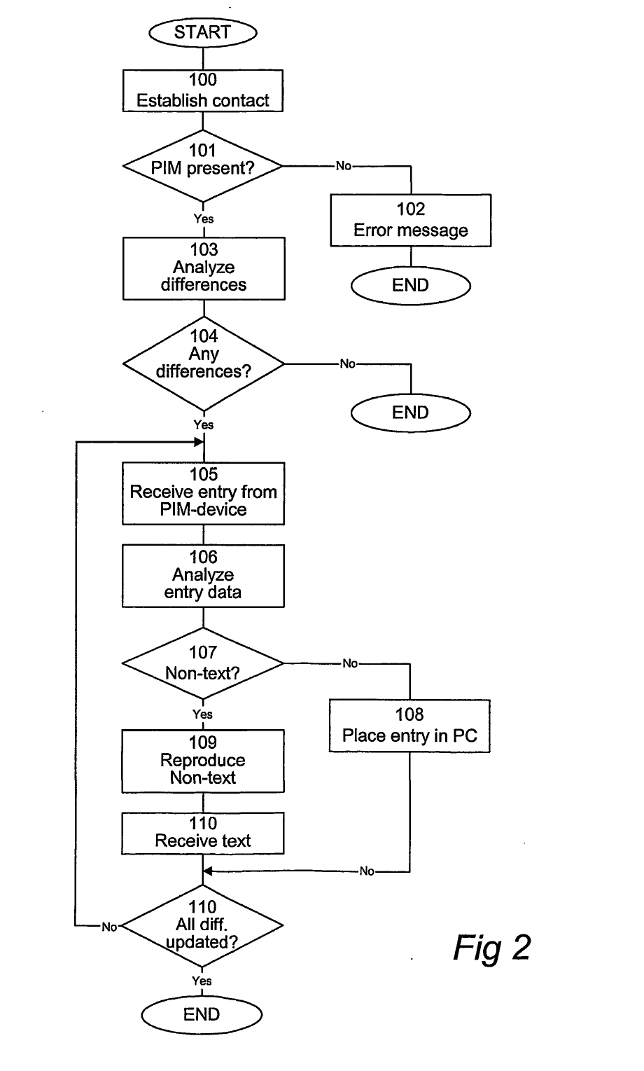

According to the invention the following procedure is proposed, which will be described with reference mainly to FIGS. 2 and 3.

The procedure described below is focused on synchronization of text- and non-text entries in electronic agendas. Since synchronization of text entries in electronic agendas is known per se, it is understood that text entries residing in the agenda 7b but not in the agenda 7a is transferred to agenda 7a during synchronization.

When the user wants to synchronize the agenda 7a on the PIM-device 1 to the agenda 7b on the stationary computer 2, a control block 12 in the synchronization engine 11, as a first step 100, tries to establish contact between the PIM-device 1 and the PC 2 via the PIM interface 13. The PIM-interface 13 may comprise different software blocks 13a, b, c, each block being adapted to transmit and receive data by means of a cable 13a, infrared light 13b, or radio 13c, respectively. In many cases though, the manufacturer of the operating system controlling the PC 2 provides the software needed to transmit and receive data. In a subsequent step 101 the control block 12 in the synchronization engine 11 determines if the PIM-device 1 is present in the system, based upon the result of step 100. If no PIM-device 1 is detected during a predefined period of time in step 101 the control block 12 will send an error message to the user interface 14 in step 102, indicating the fact that no PIM-device 1 is linked to the PC 2, whereupon the synchronization procedure ends.

On the other hand, if the result of step 101 turns out positive, the control block 13 analyzes the contents in the agendas on the PIM-device 1 and the PC 2 in step 103. By doing this, the control block 12 is able to determine if there are any differences in the contents between the two agendas in step 104. The information relating to differences between the two agendas is stored in a table 18 coupled to the control block 13. If both agendas contain the same information no synchronization is necessary and the synchronization procedure ends. Otherwise, if there are differences, the synchronization engine 11 receives entry data from the PIM-device in the PIM-interface 13 in step 105. In step 106 a non-text detection block 15 analyzes the entry data to determine, in step 107, if any non-text information is attached to the text in the agenda entry. In a preferred embodiment, the non-text information is made up from a recorded voice-memo. The present invention is however not limited to this particular case, and the non-text attachment can also comprise pictures or any other form of non-text information.

The analysis of the agenda entry is performed by studying the extension of the attachment or, if the non-text information is more integrated in the agenda entry, an API (application program interface) is used to indicate that the transferred agenda entry contains a voice-memo. If no attachment is found during step 106, the non-text detection block 15 instructs a text sync engine 16, in step 108, to insert the entry in the appropriate timeslot in the text-based agenda 17 on the PC 2. In step 111 the control block 13 then examines the table 18 to determine if all differences between the two agendas are updated. If this is not the case this will result in that the procedure returns to step 105, where the PIM-interface receives new entry data from the PIM-device. However, if both agendas contain the same information the synchronization procedure ends.

If the agenda entry contains an attachment, a non-text sync engine 19 reproduces the non-text information in conjunction with the user interface 14, in step 109.

The user interface may take various forms depending on the characteristics of the entry attachment. In the case where the attachment consists of a voice-memo, the user interface 14 reproduces the speech information by means of an audio equipment 20 coupled to the PC 2, as shown in FIG. 1. In step 110 the user is then presented with an option to write down and insert a text entry, representing the speech information, in the text-based agenda by using the keyboard 9 in FIG. 1. In the case where the agenda 7b supports non-text entries the user, as an alternative to transform the non-text entry, is presented with an option to save the non-text entry part in agenda 7b in its original format. Basically the same procedure applies when the attachment consists of a graphical image, with the difference that the user interface displays the image on the screen 10 in FIG. 1 instead of playing sound. The user may then, in his own words, transform the image information presented to him into text by using the keyboard 9, or alternatively save it in its original format.

Once the user has entered the desired text into the text-based agenda the procedure proceeds to step 111, where the control block 13 examines the table 18 to determine if all differences between the two agendas are updated. If not, the procedure returns to step 105 and the PIM-interface receives new entry data from the PIM-device. Otherwise the procedure ends and the two agendas are synchronized from an information point of view.

Information, relating to voice-notes transformed into text-only entries during the last synchronization session, is stored in the table 18 so that the control block 13 can separate updated entries from new entries in a subsequent synchronization session. This is important since the updated entries in the text-based agenda 7b on the PC 2, does not contain exactly the same information as the corresponding entries in the agenda 7a residing on the PIM-device 1.

In an alternative embodiment the user is, as a last step, presented with an option to replace the original voice booking entry in agenda 7a with the transformed synchronized text entries in agenda 7b. By doing so the two agendas will contain exactly the same information, i.e. they are fully synchronized.

The present invention has been described above with reference to a preferred embodiment. However, other embodiments than the one disclosed herein are possible within the scope of the invention, as defined by the appended independent claims.

1. An information processing system comprising a synchronization engine (11) for synchronizing a first electronic agenda (7a) comprising non-text information with a second electronic agenda (7b) for storage of text information, characterized in that
the synchronization engine (11) is adapted to receive non-text information from the first agenda (7a), reproduce the non-text information and receive text information entered by a user, corresponding to said non-text information for storage in the second agenda (7b).

2. An information processing system according to claim 1, wherein the synchronization engine (11) is adapted to synchronize text information, whereby the text information in the first agenda (7a) corresponds to the text information in the second agenda (7b).

3. An information processing system according to claim 1 or 2, wherein at least one of said electronic agendas (7ab) is located on an electronic PIM-device (1).

4. An information processing system according to claim 3, wherein the PIM-device is incorporated in a mobile communication device.

5. An information processing system according to any preceding claim, wherein the non-text information is digital sound signal data.

6. An information processing system according to any preceding claim, wherein the synchronization engine (11) is adapted to present the non-text information by a device operable to display visual data and/or to output audio data.

7. An information processing system according to any preceding claim, wherein the synchronization engine (11) is adapted to receive input text information via a keyboard (9).

8. A method for synchronizing a first electronic agenda (7a) comprising non-text information with a second electronic agenda (7b) for storage of text information, characterized by the further steps of:
receiving non-text information from the first agenda (7a) in the second agenda (7b), reproducing the non-text information, and
receiving text information entered by a user, corresponding to said non-text information for storage in the second agenda (7b).

9. A method according to claim 8, wherein at least one of said electronic agendas (7ab) is an electronic PIM-device (1).

10. A method according to claim 8 or 9, wherein the non-text information comprises digital sound signal data.

11. A method according to claims 8 to 10, wherein the non-text information is presented by a device operable to display visual data and/or to output audio data.

12. A method according to claims 8 to 11, wherein the user inputs the text information by a keyboard (9).

13. A synchronization engine (11) for synchronizing a first electronic agenda (7a) comprising non-text information with a second electronic agenda (7b) for storage of text information, characterized in that
the synchronization engine (11) is adapted to receive non-text information from the first agenda (7a), reproduce the non-text information and receive text information entered by a user, corresponding to said non-text information for storage in the second agenda (7b).

14. A synchronization engine (11) according to claim 13, wherein the synchronization engine (11) is adapted to synchronize text information, whereby the text information in the first agenda (7a) corresponds to the text information in the second agenda (7b).

15. A synchronization engine (11) according to claim 13 or 14, wherein at least one of said electronic agendas (7ab) is an electronic PIM-device (1).

16. A synchronization engine (11) according to any of the claims 13 to 15, wherein the non-text information is digital sound signal data.

17. A synchronization engine (11) according to any of the claims 13 to 16, wherein the synchronization engine (11) is adapted to present the non-text information by a device operable to display visual data and/or to output audio data.

18. A synchronization engine (11) according to any of the claims 13 to 17, wherein the synchronization engine (11) is adapted to receive input text information via a keyboard (9).

19. A computer program element directly loadable into the internal memory of an electronic communication apparatus with digital computer capabilities, characterized by comprising software code portions for performing the steps of any of the claims 1 to 11 when said product is run on said apparatus.

20. A computer program product directly loadable into the internal memory of an electronic communication apparatus with digital computer capabilities, characterized by comprising software code portions for performing the steps of any of the claims 1 to 11 when said product is run on said apparatus.
